(19) United States
(12) Patent Application Publication
(10) Pub. No.: US 2013/0100011 A1
(43) Pub. Date: Apr. 25, 2013

(54) HUMAN-MACHINE INTERFACE DEVICE

(71) Applicants: Cheng-Chung Lee, Hsinchu City (TW); Chao-Chiun Liang, Hsinchu City (TW); Ming-Hua Yeh, Taipei City (TW); Chih-Jen Chen, Tainan City (TW); Sheng-Po Wang, Taoyuan County (TW)

(72) Inventors: Cheng-Chung Lee, Hsinchu City (TW); Chao-Chiun Liang, Hsinchu City (TW); Ming-Hua Yeh, Taipei City (TW); Chih-Jen Chen, Tainan City (TW); Sheng-Po Wang, Taoyuan County (TW)

(73) Assignee: INDUSTRIAL TECHNOLOGY RESEARCH INSTITUTE, Hsinchu (TW)

(21) Appl. No.: 13/414,728

(22) Filed: Mar. 8, 2012

Related U.S. Application Data
(60) Provisional application No. 61/549,764, filed on Oct. 21, 2011.

(30) Foreign Application Priority Data
Dec. 1, 2011 (TW) 100144172

(51) Int. Cl. G09G 5/00

(52) U.S. Cl. 345/156

(57) ABSTRACT

A human-machine interface device suitable for being electrically connected to an electronic device. The human-machine interface device includes a flexible carrier having at least one flexible portion, a bending sensor, and a control module. The bending sensor is disposed on the flexible portion of the flexible carrier. The control module is disposed on the carrier, connected to the bending sensor, and electrically connected to the electronic device. A first operation signal from the bending sensor is transmitted to the electronic device through the control module so that the electronic device performs according to the first operation signal.

### CROSS-REFERENCE TO RELATED APPLICATION

This application claims the priority benefits of U.S. provisional application Ser. No. 61/549,764, filed on Oct. 21, 2011 and Taiwan application serial no. 100144172, filed on Dec. 1, 2011. The entirety of each of the above-mentioned patent applications is hereby incorporated by reference herein and made a part of this specification.

### BACKGROUND

1. Technical Field

The disclosure relates to a human-machine interface device, and more particularly to a flexible human-machine interface device.

2. Description of Related Art

As the technology of touch panels develops, current portable electronic devices are trending towards the development of touch screens as user operation interfaces. However, using touch screens as an input method has many flaws. For example, touch panels and display panels must use the same display area. Thus, when the user is executing a touch operation, the user will be unable to see the area his or her finger is contacting, and may cause error in input. In addition, to input words, images, and symbols, the display area must display a keyboard or a corresponding table of symbols for the user to perform operation. Thus, a portable electronic device that uses a touch panel as a human-machine interface must sacrifice part of the display.

In other words, even though touch panels provide a direct and simple input method, touch panels are disadvantageous in showing an entire display, and frequently have the problem of input error. Thus, how to solve the aforementioned problem, and further develop a unique operation interface is an important subject in the development of portable electronic devices.

### SUMMARY

The disclosure provides a human-machine interface device adapted to provide a variety of input operation methods for an electronic device.

The disclosure provides a human-machine interface device, adapted to increase the user entertainment of an electronic device.

The disclosure provides a human-machine interface device, adapted to electrically connect to an electronic device. The human-machine interface device includes a carrier, at least one bending sensor, and a control module. The carrier has at least one flexible portion. The bending sensor is disposed on the flexible portion of the carrier. The control module is connected to the bending sensor, and electrically connected to the electronic device. A first operation signal is transmitted to the electronic device through the control module, so that the electronic device performs according to the first operation signal.

The disclosure further provides a human-machine interface device, adapted to electrically connect to an electronic device. The human-machine interface device includes a carrier, a feedback element, and a control module. The feedback element is disposed on the carrier. The control module is connected to the feedback element, and electrically connected to the electronic device.

Based on the above, the human-machine interface device of the disclosure is flexible, allowing the user to use methods such as bending and twisting the electronic device to serve as input commands. This increases the variety of input methods of the electronic device.

Several exemplary embodiments accompanied with figures are described in detail below to further describe the disclosure in detail.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the disclosure.

FIG. 1 is a schematic diagram of a human-machine interface device according to a first embodiment of the disclosure.

FIG. 2 is a schematic diagram of a human-machine interface device according to a second embodiment of the disclosure.

FIG. 3 is a schematic diagram of a human-machine interface device according to a third embodiment of the disclosure.

FIG. 4 is a schematic diagram of a human-machine interface device according to a fourth embodiment of the disclosure.

FIG. 5 is a schematic diagram of a human-machine interface device according to a fifth embodiment of the disclosure.

FIG. 6 is a schematic diagram of a human-machine interface device according to a sixth embodiment of the disclosure.

### DETAILED DESCRIPTION OF DISCLOSED EMBODIMENTS

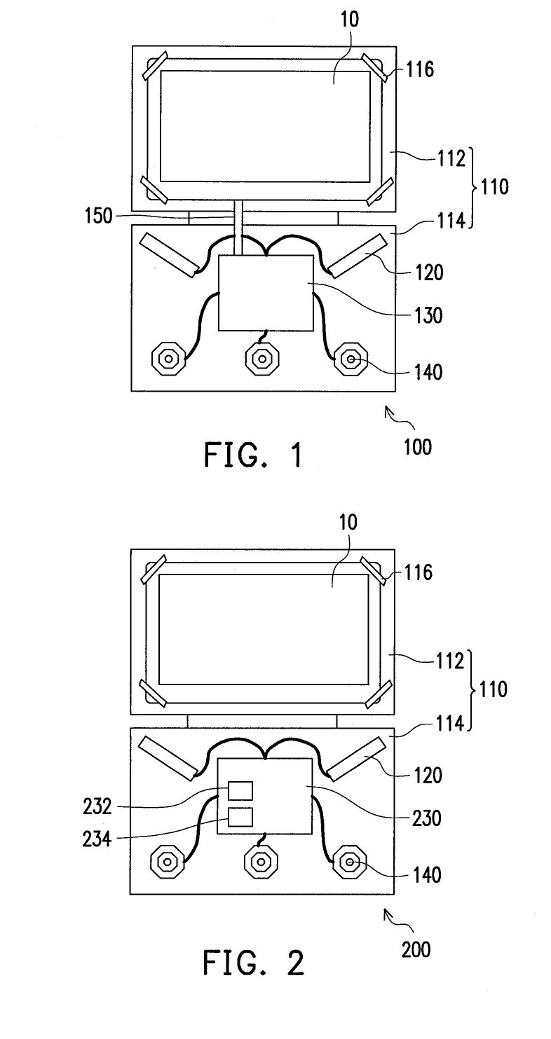

FIG. 1 is a schematic diagram of a human-machine interface device according to a first embodiment of the disclosure. Referring to FIG. 1, the human-machine interface device 100 is adapted to electrically connect to an electronic device 10. The human-machine interface device 100 includes a carrier 110, a bending sensor 120, a control module 130, a pressure sensor 140, and a transmission connection module 150. The bending sensor 120 and the pressure sensor 140 are both disposed on the carrier 110. The control module 130 is disposed on the carrier 110, and is connected to the bending sensor 120 and the pressure sensor 140. In addition, the control module 130 is electrically connected to the electronic device 10 through the transmission connection module 150. The transmission connection module 150 can include components for transmitting electronic signals such as transmission bus lines.

The electronic device 10 of the embodiment can be a portable electronic device such as a mobile phone, a laptop computer, a tablet computer, an electronic paper, or a portable game console. The human-machine interface device 100 of the embodiment can allow interaction between the user and the electronic device 10. This way the electronic device 10 will operate a command according to a corresponding motion of the user.

According to the embodiment, the carrier 110 is, for example, made of flexible material such as flexible polymer material. The carrier 110 includes a carrier portion 112 and a sensor portion 114, wherein the carrier portion 112 and the sensor portion 114 are connected to each other. The carrier portion 112 is adapted to carry the electronic device 10. The bending sensor 120 and the pressure sensor 140 are disposed on the sensor portion 114. Specifically, in order to carry and fix the electronic device 10, the carrier portion 112 of the carrier 110 includes fixing structures 116 to fix the electronic device 10. Thus, the electronic device 10 is disposed on the carrier portion 112 and is detachable.

However, the disclosure is not limited thereto. In other embodiments, the electronic device 10 can be disposed on the carrier portion 112 of the carrier 110 and is detachable through other methods (for example magnetically or adhesively). Or, in another embodiment, the electronic device 10 can be selectively fixed permanently on the carrier portion 112 of the carrier 110. In detail, in other embodiments, a composite type carrier can be selectively used to replace the carrier 110. For example, a composite type carrier can be made of different materials. A portion of the composite type carrier can be made of flexible material, and other portions can be made of rigid material. The bending sensor 120 can be disposed on the flexible portion of the composite carrier made up of flexible material, in which the flexible portion can be served as a portion or a whole of the sensor portion of the composite type carrier. The rest of the components can be selectively disposed on the flexible portion or other portions of the composite carrier.

The carrier portion 112 and the sensor portion 114 is, for example, opened or folded with respect to each other. FIG. 1 shows a state where the carrier portion 112 and the sensor portion 114 are opened with respect to each other. At this point, the sensor portion 114 will not cover the electronic device 10, and the user can see the display of the electronic device 10. When the carrier portion 112 and the sensor portion 114 are folded and closed with respect to each other, the electronic device 10 is, for example, sandwiched between the carrier portion 112 and the sensor portion 114. That is to say, when the carrier portion 112 and the sensor portion 114 are folded, the carrier portion 112 and the sensor portion 114 are respectively located on the two opposite sides of the electronic device 10. Thus, the display side of the electronic device 10 is substantially covered by the sensor portion 114, protecting the electronic device 10. It can be seen that the human-machine interface device 100 of the embodiment not only provides an interface between human and machine, but also protects the electronic device 10. The human-machine interface device 100 of the embodiment can substantially be an outer protective cover of the electronic device 10.

The bending sensor 120 and the pressure sensor 140 are disposed in order to sense the movements of the user. This allows the electronic device 10 to execute commands corresponding to the movements of the user. The bending sensor 120 can be disposed in a corner of the sensor portion 114. The user can bend or twist the corner of the sensor portion 114 to perform an input operation towards the electronic device 10. Of course, the bending sensor 120 can be disposed in other locations of the sensor portion 114, and the disclosure is not limited thereto. The pressure sensor 140 can also be selectively disposed in any location of the sensor portion 114. In addition, according to actual design requirements, the carrier 110 can be selectively disposed with only one of the bending sensor 120 and the pressure sensor 140. In other words, the embodiment does not limit the human-machine interface device 100 to simultaneously include the bending sensor 120 and the pressure sensor 140.

Since the carrier 110 has the feature of flexibility, when the user wants the electronic device 10 to perform a specific command, the user can bend the sensor portion 114 of the carrier 110. At this time the bending sensor 120 will generate a corresponding operation signal, and the electronic device 10 will execute an action corresponding to the operation signal. In addition, the user can press the sensor portion 114 of the carrier 110 so that the pressure sensor 140 senses a pressure and generates a corresponding operation signal. The electronic device 10 receives the operation signal through the control module 130 and performs a corresponding action.

In other words, besides using the conventional pressing and touching method to operate touch panels, the design of the embodiment allows the user to use a bending and/or twisting method to input operation commands toward the electronic device 10. Thus, the human-machine interface device 100 provides a variety of input methods so that the operation method of the electronic device 10 can satisfy many different requirements.

The control module 130 is mainly used to control the bending sensors 120 and the pressure sensors 140, and also connects the bending sensors 120 and the pressure sensors 140 to the electronic device 10. That is to say, the operation signal generated by the bending sensor 120 and the pressure sensor 140 when detecting movement from the user is transmitted to the electronic device 10 through the control module 130. In the embodiment, the control module 130 and the electronic device 10 can be connected through a tangible transmission connection module 150, but the disclosure is not limited thereto. In other embodiments, the control module 130 and the electronic device 10 can be connected through wireless transmission methods.

In addition, the control module 130 can control the bending sensor 120 and the pressure sensor 140 to perform or not perform sensing according to a control signal outputted by the electronic device 10. The control module 130 can use the power of the electronic device 10 to start the bending sensor 120 and the pressure sensor 140. That is to say, the bending sensor 120 and the pressure sensor 140 can directly use the power from the electronic device 10, and does not require additional external power. However, in other embodiments, the control module 130 can have a power source unit internally that provides the required power to start the bending sensor 120 and the pressure sensor 140.

When the user operates the electronic device 10 with the human-machine interface device 100, the electronic device 10 is not directly touched, and so the images displayed on the electronic device 10 are not affected. Thus, the human-machine interface device 100 of the embodiment can solve the problem of affecting the display in conventional touch panels that require direct operation on the electronic device. At the same time, since the user operations are not applied on the electronic device 10 itself, damages from user operation movements toward the electronic device 10 are avoided. In addition, the design of the human-machine interface device 100 does not require the electronic device 10 to be flexible, and still allows the user to perform input through bending. Thus, the human-machine interface 100 allows the operation method of the electronic device 10 to have more variation, which raises the entertainment of operating the electronic device 10.

FIG. 2 is a schematic diagram of a human-machine interface device according to a second embodiment of the disclosure. Referring to FIG. 2, the human-machine interface device 200 is similar to the human-machine interface device 100 of the first embodiment. Similar components of the two embodiments will use similar reference numbers. Specifically, the difference between the human-machine interface device 200 and the human-machine interface device 100 of the previous embodiment is that in the embodiment, a control module 230 includes a power source unit 232 and a wireless transmission unit 234. The human-machine interface device 200 does not require a tangible transmission connection module. That is to say, the wireless transmission unit 234 can provide a wireless communication function that allows the control module 230 and the electronic device 10 to be electrically connected. In addition, the power source unit 232 can independently provide the power required to start the bending sensor 120 and the pressure sensor 140, and the power from the electronic device 10 does not need to be used to start the bending sensor 120 and the pressure sensor 140.

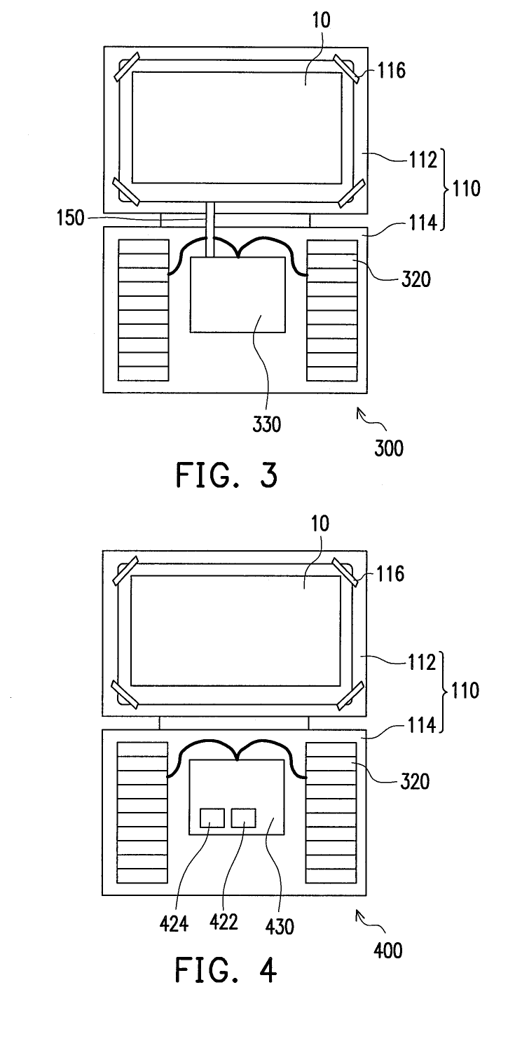

FIG. 3 is a schematic diagram of a human-machine interface device according to a third embodiment of the disclosure. Referring to FIG. 3, the human-machine interface device 300 includes a carrier 110, a feedback element 320, a control module 330, and a transmission connection module 150. In addition, the human-machine interface device 300 of the embodiment is, for example, connected to the electronic device 10. The carrier 110 and the transmission connection module 150 are similar to the carrier 110 and the transmission connection module 150 of the first embodiment. The design and function of these components can be referred to in the first embodiment. In the embodiment, the feedback element 320 is disposed on the sensor portion 114 of the carrier 110. The control module 330 can be connected to the electronic device 10 through the transmission connection module 150, and is connected to the feedback element 320. Thus, the actions of the feedback element 320 can interact with the electronic device 10. That is to say, the feedback element 320 can perform actions according to command signals from the electronic device 10.

For example, the feedback element 320 can be a tactile feedback element, a visual feedback element, an audio broadcaster or any combination of the above. The tactile feedback element includes a vibrating element, an actuator, or an electrical stimulating feedback element. The visual feedback element can be flashing lights, an extension display device, or other structures that can output light or images. In other words, the design of the feedback element 320 generates a stimulation for the user to feel. When the user uses the electronic device 10, besides the audio and visual effects provided by the electronic device 10 itself, the user can experience additional various stimulations that raise the entertainment of using the electronic device 10.

FIG. 4 is a schematic diagram of a human-machine interface device according to a fourth embodiment of the disclosure. Referring to FIG. 4, the human-machine interface device 400 is similar to the human-machine interface device 300 of the third embodiment. Similar components of the two embodiments will use similar reference numbers. Specifically, the difference between the human-machine interface device 400 and the human-machine interface device 300 of the previous embodiment is that in the embodiment, a control module 430 includes a power source unit 432 and a wireless transmission unit 434. The human-machine interface device 400 does not require a tangible transmission connection module. That is to say, the wireless transmission unit 434 can provide a wireless communication function that allows the control module 430 and the electronic device 10 to be electrically connected. In addition, the power source unit 432 can independently provide the power required to start the feedback element 320, and the power from the electronic device 10 does not need to be used to start the feedback element 320.

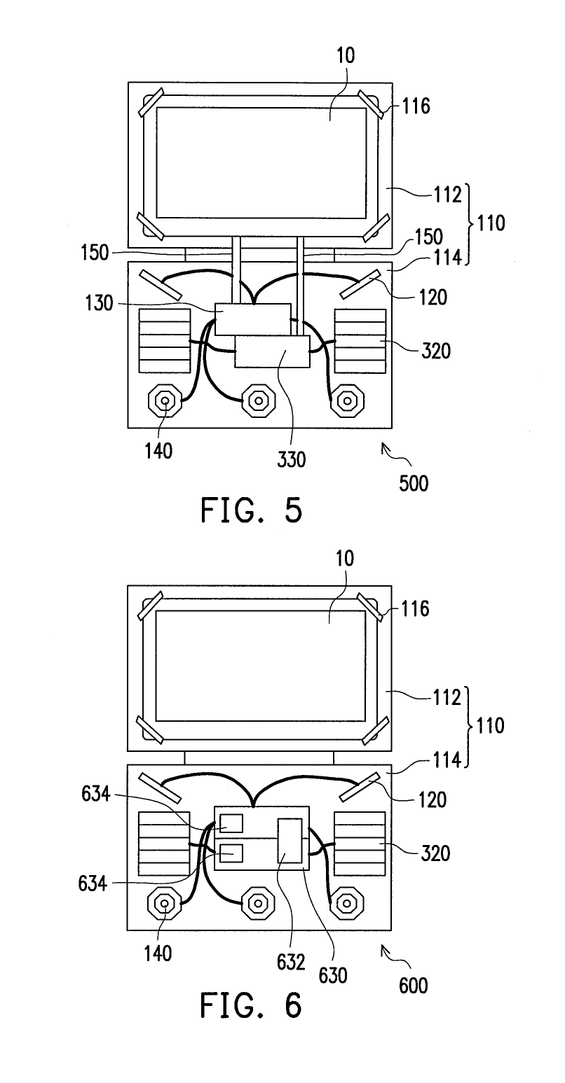

FIG. 5 is a schematic diagram of a human-machine interface device according to a fifth embodiment of the disclosure. Referring to FIG. 5, a human-machine interface device 500 similar to the previous embodiments, is adapted to electrically connect to the electronic device 10. The human-machine interface device 500 includes a carrier 110, a bending sensor 120, control modules 130, 330, a pressure sensor 140, a transmission connection module 150, and a feedback element 320. The functions and designs of the carrier 110, the bending sensor 120, the control modules 130, 330, the pressure sensor 140, the transmission connection module 150, and the feedback element 320 can be referred to in the previous embodiments, and will not be repeated herein. Specifically, the embodiment has combined the design of the previous embodiments to provide a human-machine interface device 500 that can perform operation inputs and also provide unique stimulations.

In the embodiment, the bending sensor 120 and the pressure sensor 140 can provide the user to perform different input actions such as bending, twisting, hitting, pressing, and flipping. At the same time, the control module 130 and the control module 330 can be electrically connected to the feedback element 320, and act according to the operation signals sensed by the bending sensor 120 and the pressure sensor 140. Thus, when the user is performing input actions, the user can simultaneously sense the stimulations generated by the feedback element 320, which greatly raises the entertainment value when operating the electronic device 10. Of course, the feedback element 320 can be similar to the previous embodiment, and act according to the commands issued by the electronic device 10.

The embodiment shows the control module 130 and the control module 330 as two blocks. However, in other embodiments, the bending sensor 120, the pressure sensor 140, and the feedback element 320 can be controlled with just one control module. In addition, the control module 130 and the control module 330 is connected to the electronic device 10 through the transmission connection module 150, but the disclosure is not limited thereto. FIG. 6 is a schematic diagram of a human-machine interface device according to a sixth embodiment of the disclosure. Referring to FIG. 6, the human-machine interface device 600 is similar to the human-machine interface device 500 of the fifth embodiment. Similar components of the two embodiments will use similar reference numbers. Specifically, the difference between the human-machine interface device 600 and the human-machine interface device 500 of the previous embodiment is that in the embodiment, a control module 630 includes a power source unit 632 and a wireless transmission unit 634. The human-machine interface device 600 does not require a tangible transmission connection module. That is to say, the wireless transmission unit 634 can provide a wireless communication function that allows the control module 630 and the electronic device 10 to be electrically connected. The amount of the wireless transmission unit 634 can be two, to respectively connect the bending sensor 120 and the pressure sensor 140 used for sensing and connect the feedback element 320 used for stimulating to the electronic device 10, however the disclosure is not limited thereto. In addition, the power source unit 632 can independently provide the power required to start the bending sensor 120, the pressure sensor 140, and the feedback element 320, and the power from the electronic device 10 does not need to be used to start the bending sensor 120, the pressure sensor 140, and the feedback element 320.

To sum up, the human-machine interface device of the disclosure can provide an input interface independent from an electronic device. The human-machine interface device can provide various input methods besides a pressing method, which improves the variety of the electronic device. In addition, the human-machine interface device of the disclosure can generate unique stimulations for the user to sense, which improves the entertainment value when using the electronic device.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A human-machine interface device, suitable to be electrically connected to an electronic device, the human-machine interface device comprising:
a carrier, having at least one flexible portion;
at least one bending sensor, disposed on the flexible portion of the carrier; and
a control module, disposed on the carrier, connected to the bending sensor, and electrically connected to the electronic device, wherein a first operation signal is transmitted to the electronic device through the control module so that the electronic device performs according to the first operation signal.

2. The human-machine interface device as claimed in claim 1, further comprising a transmission connection module, connecting the control module to the electronic device.

3. The human-machine interface device as claimed in claim 1, wherein the control module comprises a wireless transmission unit, so as to wirelessly electrically connect to the electronic device.

4. The human-machine interface device as claimed in claim 1, wherein the first operation signal is generated by the bending sensor and changed with a speed, an intensity, or a direction of a user's bending motion on the carrier.

5. The human-machine interface device as claimed in claim 1, further comprising a pressure sensor, disposed on the carrier and connected to the control module, wherein the first operation signal is generated by the pressure sensor.

6. The human-machine interface device as claimed in claim 1, further comprising a feedback element, disposed on the carrier and connected to the control module.

7. The human-machine interface device as claimed in claim 6, wherein the feedback element performs according to a command signal from the electronic device.

8. The human-machine interface device as claimed in claim 6, wherein the feedback element performs according to the first operation signal.

9. The human-machine interface device as claimed in claim 6, wherein the feedback element comprises a tactile feedback element, a visual feedback element, an audio broadcaster or any combination of the above.

10. The human-machine interface device as claimed in claim 9, wherein the feedback element comprises a vibrating element, an actuator, or an electrical stimulating feedback element.

11. The human-machine interface device as claimed in claim 1, wherein the carrier comprises a carrier portion for carrying the electronic device, and a sensor portion connected to the carrier portion, wherein the sensor portion comprises the flexible portion and the bending sensor is located on the sensor portion.

12. The human-machine interface device as claimed in claim 11, wherein the sensor portion is adapted to be opened and folded with respect to the carrier portion so that the sensor portion and the carrier portion are respectively located on two opposite sides of the electronic device when the sensor portion and the carrier portion are folded with respect to each other.

13. The human-machine interface device as claimed in claim 12, wherein when the carrier portion and the sensor portion are opened, the sensor portion essentially does not cover the electronic device.

14. The human-machine interface device as claimed in claim 11, wherein the electronic device can be disposed on the carrier portion of the carrier and is detachable.

15. The human-machine interface device as claimed in claim 1, wherein the electronic device is a portable electronic device.

16. A human-machine interface device, suitable to be electrically connected to an electronic device, the human-machine interface device comprising:
a carrier;
a feedback element, disposed on the carrier; and
a control module, disposed on the carrier, connected to the feedback element, and electrically connected to the electronic device.

17. The human-machine interface device as claimed in claim 16, further comprising a transmission connection module, connecting the control module to the electronic device.

18. The human-machine interface device as claimed in claim 16, wherein the control module comprises a wireless transmission unit, so as to wirelessly electrically connect to the electronic device.

19. The human-machine interface device as claimed in claim 16, further comprising a pressure sensor, disposed on the carrier and connected to the control module, wherein an operation signal from the pressure sensor is transmitted to the electronic device through the control module so that the electronic device performs according to the operation signal.

20. The human-machine interface device as claimed in claim 16, wherein the feedback element performs according to a command signal from the electronic device.

21. The human-machine interface device as claimed in claim 16, wherein the feedback element comprises a tactile feedback element, a visual feedback element, an audio broadcaster or any combination of the above.

22. The human-machine interface device as claimed in claim 21, wherein the feedback element comprises a vibrating element, an actuator, or an electrical stimulating feedback element.

23. The human-machine interface device as claimed in claim 16, wherein the carrier comprises a carrier portion for carrying the electronic device, and a sensor portion connected to the carrier portion, wherein the feedback element is located on the sensor portion.

24. The human-machine interface device as claimed in claim 23, wherein the sensor portion and the carrier portion are suitable to be opened and folded with respect to each other, and the sensor portion and the carrier portion are respectively located on two opposite sides of the electronic device when the sensor portion and the carrier portion are folded with respect to each other.

25. The human-machine interface device as claimed in claim 24, wherein when the carrier portion and the sensor portion are opened, the sensor portion essentially does not cover the electronic device.

26. The human-machine interface device as claimed in claim 23, wherein the electronic device can be disposed on the carrier portion of the carrier and is detachable.

27. The human-machine interface device as claimed in claim 16, wherein the electronic device is a portable electronic device.
